(19) United States
(12) Patent Application Publication
(10) Pub. No.: US 2009/0226028 A1
(43) Pub. Date: Sep. 10, 2009

(54) Loudspeaker, Speaker Diaphragm, and Suspension

(75) Inventor: Tadao Suganuma, Hachioji-shi (JP)

Correspondence Address: OLIFF & BERRIDGE, PLC, P.O. BOX 320850, ALEXANDRIA, VA, 22320-4850, US

(73) Assignee: Beam-Tech Corporation, Hachioji-shi, TOKYO (JP)

(21) Appl. No.: 11/991,935

(22) PCT Filed: Sep. 19, 2006
(86) PCT No.: PCT/JP2006/318507

§ 371 Date: Apr. 10, 2008

(30) Foreign Application Priority Data
Sep. 20, 2005 (JP) 2005-305008

(51) Int. Cl. H04R 1/00

(52) U.S. Cl. 381/430; 381/423

(57) ABSTRACT

The present invention relates to a hi-fi speaker. The diaphragm (1) is comprised of a frame member (2) and filler members (3) filled in the frame member (2). The frame member is comprised of flat plates all of which are arranged in parallel to the vibration direction and radially from the center of the diaphragm (1) toward the outer circumference, are fastened together at the radial center, and are fastened to the drive part (6). This frame member (2) has a high rigidity. The filler members (3) are comprised of foamed material etc. This diaphragm (1) does not have any skins, therefore also does not have any problem with resonance. The sound is emitted from the filler members (3). In the suspension (7), rod-like members (12) are fastened in a line at the both ends of the first leaf spring (11), second leaf springs (13) are fastened to the both ends of the rod-like members perpendicular to the rod-like members, and the both ends of the second leaf springs are fastened to unmovable parts of the speaker. The characteristic resonance occurring inside this suspension is slight and there is little displacement in directions other than the vibration direction. It is possible to use the present invention to form an edgeless plane diaphragm speaker system free of the effects of characteristic resonance and reproducing sound with a high fidelity.

### TECHNICAL FIELD

The present invention relates to a loudspeaker, a speaker diaphragm, and a suspension, in particular relates to a hi-fi speaker able to reproduce sound with a high fidelity and a diaphragm and a suspension suitable to realizing a speaker having such a property.

### BACKGROUND ART

A typical example of a conventional loudspeaker is called a “cone speaker”. This has a conical shaped diaphragm. The sound emitted from here is disturbed in frequency characteristics or disturbed in phase characteristics since the emitting surface is not a flat surface, but is a conical shape. This is a major defect in a hi-fi speaker. To eliminate this defect, for example as shown in Patent Document 1, a plane diaphragm having a shape of plane surface has been proposed.

Further, the outer circumference of a conventional plane diaphragm is supported by a member called an “edge”. An edge is comprised of an elastic material, so easily resonates. This characteristic resonance enters into the reproduced sound as noise and degrades the sound quality. As a countermeasure for this, for example, as shown in Patent Document 2, an edgeless structure eliminating the use of an edges has been proposed.

Furthermore, in the past, an edgeless plane diaphragm speaker using the above two ideas has been proposed. Below, an edgeless plane diaphragm speaker will be explained with reference to FIG. 6 to FIG. 13. In the figures, when there are identical members or a large number of designated locations, a single representative one is assigned a reference notation.

FIG. 9 is a cross-sectional view of a conventional typical edgeless plane diaphragm speaker. In the figure, 31 indicates a plane diaphragm. A partially cutaway view is shown in FIG. 10. In FIG. 9 and FIG. 10, 32 indicates a core formed by folding thin sheets into hexagonal shapes. 33 and 34 are thin sheets called “skins”. By attaching the skins 33 and 34 to both open ends of the core 32, hollow cells 35 are formed. A large number of cells are arranged in a flat plate shape whereby a honeycomb structure plane diaphragm 31 is formed. The core 32 and the skins 33 and 34 are comprised of metal, hard plastic, or another high rigidity material. Further, instead of a hexagonal-structure core, a diaphragm arranging short ribs in a radial shape to form a core and attaching the skins to the two sides has been proposed (for example Patent Document 3). Its plan view is shown in FIG. 11, while its front view is shown in FIG. 13. In this case as well, hollow cells 35 are formed surrounded by the skins 33 and 34 and the core 32. The large number of cells 35 form a plane diaphragm 41.

In FIG. 9, a voice coil bobbin 4 is fastened to the skin 34. A voice coil 5 is wound around the bobbin 4. The bobbin 4 and the coil 5 together form a drive part 6. The lateral side of the bobbin 4 is provided with openings 38 at several locations. The openings are provided to allow the ventilation of air since, if the air were sealed in the bobbin 4, free movement of the vibration system would be inhibited.

The bobbin 4 is supported by two suspensions 37. The suspensions 37 are comprised of resin-impregnated fabrics with concentric circular surface reliefs and are called “corrugated dampers”. The diaphragm, the drive part, and the suspensions are referred to all together as the “vibration system”. 24 indicates a columnar shaped internal magnetic pole, while 23 indicates an external magnetic pole having a circular opening. The coil 5 is positioned in the gap formed between the two poles. 25 indicates a columnar shaped magnet, while 26 indicates a U-shaped yoke.

A frame 21 has a cylindrical surface 22 at the inner side. In a conventional type speaker, there is a member called an “edge” connecting the outer circumference of the diaphragm 31 and the inner side of the frame 21. on the other hand, in an edgeless speaker, the clearance between the outer circumference of the diaphragm 31 and the inner cylindrical surface 22 forms a ring-shaped space running along the periphery. If input current flows through the coil 5, the bobbin 4 vibrates in the Z-direction. This vibration is transmitted through the skin 34 to the core 32, then is transmitted to the skin 33, whereby the surface of the skin 33 emits the reproduced sound.

The above-mentioned edgeless plane diaphragm speaker eliminates the many defects of edged cone type speakers and has the possibility of reproducing original sound with an extremely high fidelity. This can be said to be ideal for a hi-fi speaker. There are, however, several unsolved problems for commercializing this and obtaining the targeted high performance. These will be explained below.

If characteristic resonance occurs in the diaphragm of the speaker, this enters into the reproduced sound as noise and lowers the fidelity of the reproduced sound. Completely eliminating the characteristic resonance may be said to be impossible, but if the resonance frequency is shifted upward, it is possible to set the usable bandwidth of the speaker at below the resonance frequency and thereby substantially avoid the effects of resonance. Therefore, it is desirable that a diaphragm has a high rigidity and a high resonance frequency. However, the conventional plane diaphragm 31 did not have a sufficiently high rigidity and suffered from resonance at a low frequency and lowered the fidelity of the reproduced sound. The cause will be explained by FIG. 6 to FIG. 8. In the figures, the plate 2 is fastened at one end G. A force F is applied to the opposing end. In FIG. 6, the force F is applied in a direction perpendicular to the surface of the plate, and in this case, the plate ends up easily bending as shown by the chain line. Next, as shown in FIG. 7, bending is difficult when the direction of the force F is parallel to the direction of the plate. In FIG. 8, the direction of the plate is parallel to the direction of the force, but the plate is folded at two locations midway. In this case, a force perpendicular to the surface J acts on the surface, so the surface J is easily twisted and the plate ends up bending as shown by the chain line. From this, it is learned that what is most difficult to bend and is high in rigidity is the case of FIG. 7 where the plate is not folded, but flat and is arranged parallel to the direction of the force. Above, the case where a static force is applied to the plate was explained, but the same can also be said for the case where a dynamic force, that is, vibration force, is applied. Further, the same applies to the case where both ends of the plate are fastened and force is applied to the center part.

Furthermore, as another prior art, there is for example the art described in Patent Document 4.

Patent Document 1: Japanese Patent Publication (A) No. 61-70898

Patent Document 2: Japanese Patent Publication (A) No. 57-35499

Patent Document 3: Japanese Patent Publication (A) No. 60-22899

Patent Document 4: Japanese Patent Publication (A) No. 58-63294

### DISCLOSURE OF THE INVENTION

### Problems to be Solved by the Invention

Based on the above explanation, a conventional plane diaphragm of a speaker will be considered. An enlarged view of one cell of the plane diaphragms 31 and 41 shown in FIG. 9 and FIG. 13 is shown in FIG. 12. Here, Z indicates the direction of the vibration force or the vibration occurring due to this. As clear from the figures, the skins 33 and 34 and the vibration direction Z are perpendicular to each other. This is the same as the directional relationship of the plate and force shown in FIG. 6. Therefore, if a vibration force is applied, the skins 33 and 34 easily bend as shown by the chain line in FIG. 12 and end up resonating at a low frequency. This phenomenon is also described in for example Patent Document 4. In this way, it has been known that the skins 33 and 34 resonate and degrade the sound quality, but in the conventional diaphragms 31 and 41, the skins 33 and 34 and the core 32 together form the frameworks of the diaphragms, and if removing the skins 33 and 34, the diaphragms 31 and 41 are not formed. Further, the skins 33 and 34 also serve as sound emitting surfaces, so the skins 33 and 34 cannot be removed. Insofar as the skins 33 and 34 are present, elimination of their resonance is difficult and the problems cannot be solved.

Further, the core 32 also has a resonance problem. As shown in FIG. 10, the honeycomb structure core 32 is formed by folding sheets. This is the same state as FIG. 8. Therefore, the core 32 easily bends and ends up characteristically resonating. Further, high rigidity materials are used for the core 32 and skins 33 and 34, and in general high rigidity materials have small internal loss. Therefore once characteristic resonance occurs, it will not easily be damped. No measures have been taken against this problem. In the above way, a conventional plane diaphragm had the problem of characteristic resonance due to the skins and core.

Further, while overlooked in the past, the suspensions 37 also have a characteristic resonance problem. When the speaker is driven, the vibration system vibrates by a certain frequency determined by the spring constants of the suspensions 37 and the mass of the vibration system. This is called the free air resonance and is useful for reproduction of low frequency sound. However, in addition to this, characteristic resonance occurs inside the suspensions 37. This resonance is transmitted to the diaphragm where it is emitted as noise and becomes harmful when sensed by the listener. Therefore, to realize true high fidelity reproduction, it is necessary to eliminate the characteristic resonance of not only the diaphragm, but also the insides of the suspensions. However, the conventionally frequently used corrugated dampers are flexible since they are made of a soft resin-impregnated fabrics. Therefore, it is not avoidable that the dampers resonate on its inside at a low frequency and degrade the quality of the reproduced sound.

Further, there are inherent problems in an edgeless speaker. These will be explained below.

As shown in FIG. 9, there is a ring-shaped space between the outer circumference of the diaphragm 31 and the inner cylindrical surface 22 of the frame 21. The front and back of the speaker are acoustically short-circuited through this inner-shaped space, whereby the sound pressure level in the low frequency falls. To prevent this problem, it is necessary to acoustically insulate the short-circuit of the front and back. For this, it is effective to make the width of the above space narrower (preferably 0.5 mm or less) and make it longer in the vibration direction (preferably 10 mm or more). To form such a narrow and long space, the cylindrical surface of the frame and the outer circumference of the diaphragm have to be accurately formed and the diaphragm has to be thick. The cylindrical surface of the frame can be formed in this way, but the precision forming of the diaphragm is difficult, since diaphragm is comprised of cores and skins which are made of thin sheets. Further, a conventional diaphragm is relatively large in specific gravity, so if increasing the thickness, becomes heavier, whereby the speaker efficiency falls, the rolling phenomenon described below occurs, and other problems arise.

A diaphragm not supported at its outer circumference by an edge tends to be displaced in the direction perpendicular to the vibration direction and suffer from “rolling”. When the clearance between the diaphragm 31 and the cylindrical surface 22 of the frame 21 is narrow, even slight rolling causes the diaphragm 31 to contact the frame where an unpleasant noise is emitted and the function as a speaker is not achieved. Essentially, the suspension 37 ought to function to hold the vibration system centered about the speaker and is required not to displace outside of the vibration direction. In an edgeless speaker, this demand is particularly severe for the above reasons. However, conventional dampers have the above structure and materials, so can displace somewhat in the direction perpendicular to the vibration direction as well, and its aging deformation is also unavoidable. So it was difficult to constantly maintain the vibration system in the center of the speaker at a high precision.

The problems explained above have not been solved, so edgeless plane diaphragm speakers have not been commercialized much at all. Cone type speakers having edges with all of their defects are mostly being used at the present.

### Means for Solving the Problems

The present invention enables the formation of a flat plate diaphragm without the use of skins and thereby fundamentally resolves the problem of skin resonance. The suspensions are comprised of only hard materials, therefore the characteristic resonances at the insides are greatly suppressed. Further, the present invention solves the other problems explained above at the same time. The speakers to which the present invention can be applied are not limited to edgeless plane diaphragm speakers, but if applied to such speakers, the features of the present invention can be best exhibited.

The diaphragm according to the present invention is comprised of a frame member for maintaining the stiffness of the diaphragm high and filler members arranged filling the frame member. The frame member is comprised of a plurality of flat plates (hereinafter referred to as “plate members”) all of which are arranged in parallel to the vibration direction and radially from the center of the diaphragm toward the outer circumference, have ends fastened together at the center of the radial shape, and are fastened to the drive part. There are neither plates perpendicular to the vibration direction like the skins in the prior art, nor sheets which are bent like a honeycomb core. That is, all of the frame member is arranged in the state of the above-mentioned FIG. 7 and therefore is hard to bend and is high in stiffness. Further, in a conventional diaphragm, vibration of the drive part is transmitted through the skins to the core, but in the present invention, is directly transmitted from the drive part to the frame member, so the transmission efficiency is high and no resonance occurs. The frame member exclusively acts to transmit vibration and does not emit almost any sound. On the other hand, the filler members are fastened at their side surfaces to the frame member and act to transmit vibration from the frame member and emit sound from the surface. The frequency of the characteristic resonance of the thus configured diaphragm is high, and the effect of the resonance on the reproduced sound can be substantially eliminated.

Further, in the suspension, rod-like members are fastened in a line at both ends of the first leaf spring, second leaf springs are fastened perpendicularly to the rod-like members at both ends of the rod-like members, and both ends of the second leaf springs are fastened to unmovable parts of the speaker. The materials used here may be stiff ones, so the characteristic resonance occurring inside is extremely small. If using the above explained diaphragm and suspensions to form the vibration system of the speaker, it is possible to substantially eliminate the effects of characteristic resonance from all parts of the vibration system.

Further, in the present invention, the outer circumferential end of the frame member is inside of the outer circumferential end of the diaphragm. That is, the outer circumference of the diaphragm is comprised of only the filler members. So it is possible to form this part to obtain a diaphragm having a high roundness and precision of diameter. Further, this diaphragm can be made thicker without the mass becoming excessive. Further, the suspensions have a degree of freedom in just the vibration direction and never displace in other directions. If using this diaphragm and suspensions, it is possible to make the space between the diaphragm and frame narrower and longer. As a result, it is possible to acoustically insulate the front of the edgeless speaker from the back and reproduce low frequency sound with a sufficient sound pressure level.

Further, in the present invention, ventilation cutaways are provided at least at one of the filler members and drive part. Openings are formed by these cutaways. Air can freely pass between the inside and outside of the drive part through the openings. As a result, the vibration system is not inhibited from movement. This is advantageous for reproduction of low frequency sound.

### BEST MODE FOR CARRYING OUT THE INVENTION

Embodiments of the present invention will be explained with reference to FIG. 1 to FIG. 3. FIG. 1 is a perspective view of a vibration system of a speaker. This is comprised of a diaphragm 1, a drive part 6, and suspensions 7. Z indicates the vibration direction. The left side in the figure is forward and the right side is backward. To facilitate understanding, one of the filler members 3 and the drive part 6 are illustrated in the state separated from the members to be fastened to.

In FIG. 1, 1 indicates a disk-shaped diaphragm. The diameter is selected as for example 120 mm and the thickness for example 20 mm. This diaphragm 1 has a small specific gravity, so even if made this thick, the mass will not become excessive.

2 is a frame member. This is comprised of a plurality of flat plate members of the identical shape. There are six plate members in this embodiment. All of the plate members are arranged in parallel to the vibration direction Z and radially at substantially equal angular intervals with respect to the circumferential direction and have ends fastened together at the radial center D. The width of the frame member 2 in the Z-direction is preferably selected to be approximately equal to the thickness of the diaphragm 1. The frame member 2 is preferably light in weight and high in stiffness. For this reason, the material is preferably aluminum, titanium, beryllium, carbon, etc., while the thickness is preferably 0.1 mm or less.

3 indicates a thick fan-shaped filler member. There are six of these in the present embodiment. The filler members 3 are arranged filling the spaces formed between each two adjoining plate members 2. The two side surfaces of the filler members 3 are fastened to the frame members 2 by adhesion, tackiness, or other means. The material is a low density one, for example, a foam of plastic, metal, carbon or other materials. The filler members 3 have thick block shapes and have large internal losses, so themselves are resistant to characteristic resonance. Not only this, they also act to suppress the resonance of the frame member 2. Further, as illustrated, the outer circumferential ends of the frame member 2 do not reach the outer circumference of the diaphragm 1 and are positioned at the inside. That is, the outer circumference of the diaphragm 1 is comprised of only the filler members (foams) 3, so the part can be formed to achieve the necessary roundness and precision of diameter.

The drive part 6 is comprised of a bobbin 4 and a coil 5 wound around the same. The drive part 6 is fastened to the edges of the same side of the frame member 2 at six locations F. (In FIG. 1, the black dots show the fastening locations). Note that here the bobbin 4 is not necessary required. For example, the coil can be wound without using a bobbin and solidified by an adhesive to form a cylindrical shape. This may then be a drive part fastened to the frame member 2.

In this embodiment, four suspensions 7 are used. Among these, two suspensions 7 are fastened to the rear edges of the frame member 2, while the other two are fastened to the rear edge of the drive part 6. The mounting positions of the suspensions 7 are not limited to this embodiment. For example, all four may also be mounted to either the diaphragm 1 or the drive part 6. Further, the number is also not limited to four.

If an input current flows through the coil 5, the drive part 6 vibrates in the Z-direction. This vibration is transmitted to the frame member 2, then is transmitted to the filler members 3, whereby the diaphragm 1 emits sound.

FIG. 1 shows ventilation cutaways 8 formed by gouging out parts of the surface of the filler members 3 in semispherical shapes and ventilation cutaways 9 formed by cutting away parts of the end of the drive part 6 into semicircular shapes. These cutaways are provided at six facing locations of the filler members 3 and drive part 6. When the frame member 2 and the drive part 6 are fastened, the cutaways provided at the filler members 3 and drive part 6 form openings. Air can freely enter and leave the drive part through the openings, so the vibration system is never hindered from operation. These openings are also shown in FIG. 3. The shapes of the cutaways are not limited to the ones explained above and for example may also be box and block shapes. Further, the cutaways may be provided at just one of the filler members 3 and drive part 6 so as to achieve the object of ventilation.

The number of the plate members 2 is not limited to the above and may be suitably determined in accordance with the size of the diaphragm 1 and the performance sought. The number of filler members 3 may also be determined in accordance with this. Further, the filler members 3 need not be completely separated. They may be connected each other at the front surface of the diaphragm 1. The frame member 2 may be arranged slightly recessed from the front surface of the diaphragm 1. In this case as well, the filler members 3 may be substantially deemed to be a plurality of fan-shaped members. Note that in the above-mentioned embodiment, the diaphragm 1 is disk shaped, but the diaphragm is not limited to this shape. That is, the front surface and rear surface of the diaphragm 1 need not be flat. They may also be made convex, concave, or otherwise shaped as well. However, if at least the front surface is made flat, the advantage arises that the sound emitted from there will be in the same phase, so this is preferable. Further, the diaphragm may be formed into a shape having not only a circular circumference, but also an elliptical, rectangular, or other circumference. In this case, some of the plate members 2 and some of the filler members 3 will be different in shape. Further, the plate members 2 can be arranged at different angular intervals in the circumferential direction. In this case as well, some of the filler members 3 will be different in shape. Further, a part of the surface or inside of the diaphragm 1 may be cut away to reduce the weight while maintaining the stiffness, or other changes may be made to the shape. In any case, the shapes and dimensions of the frame member 2 and the filler members 3 may be suitably changed in a range not deviating from the gist of the present invention.

The method of forming the diaphragm 1 is not limited to the above. It is also possible to arrange at first the frame member 2, then inject a foam material there, and make it foam so as to form the filler members 3. Further, in addition, it is possible to adhere fan-shaped filler members 3 each other at their side surfaces by a ceramic adhesive etc., then allow the adhesive to cure to obtain a highly stiff plate and consequently form a “frame member”.

Next, the detailed structure of a suspension 7 will be explained with reference to FIG. 2. 11 indicates a first leaf spring. 14 indicates a connecting piece for connecting the suspension 7 to the diaphragm 1 or drive part 6. One end of the connecting piece 14 is fastened to the center of the leaf spring 11, while the other end B is fastened to the diaphragm 1 or drive part 6. Rod-like members 12 are fastened in a line at the both ends of the leaf spring 11. Here, the “rod-like member” includes not only a solid member, but also a member with part of its thickness cut away to reduce the weight, that is, a pipe, and further a member with a T-shaped or cross-shaped cross-section. Second leaf springs 13 are fastened to the both ends of the rod-like members perpendicular to the rod-like members. The ends C of the second leaf springs are fastened to unmovable parts of the speaker. As the material of the members of the suspension 7, metal, carbon, hard plastic, and other stiff materials are suitable.

The leaf spring 11 and connecting piece 14 can move in the Z-direction by this spring bending. At that time, the rod-like members 12 have to incline, and this is realized by the leaf springs 13 bending. This suspension, as clear from the structure, does not have any freedom in the Y-direction. Displacement in the X-direction can occur by the two leaf springs 13 bending together in the same X-direction, but no force making the leaf springs 13 bend in this way usually occurs. When this is a concern, the freedom in the X-direction can be eliminated by preventing the leaf springs 13 from bending outside by the forces due to rigid walls outside of the two leaf springs 13 in contact with these springs. In the figure, the rigid walls are not shown, but the forces due to the walls are shown by E. The suspension configured in the above way has a freedom only in the Z-direction. In other directions, the suspension is extremely rigid and will not displace.

Further, this suspension 7 is made using a stiff material, so characteristic resonance is hard to occur. But a slight higher order resonance may occur in the leaf spring 11. To prevent this, two connecting pieces may be used attached to the vicinity where both ends of the leaf spring 11 and the rod-like members 12 contact, then this higher order resonance is eliminated.

An edgeless plane diaphragm speaker configured using the diaphragm 1, drive part 6, and suspensions 7 explained above will be explained below. FIG. 3 is a front view of the edgeless plane diaphragm speaker. However, just the frame 21 is shown by a cross-sectional view whereby its insides are shown. When components already explained are used again in this figure, the same notations are attached and explanations will be omitted.

In FIG. 3, the plane diaphragm 1 has for example a diameter of 120 mm and a thickness of 20 mm. The outer circumference foam, that is, filler members 3, is precisely formed so that its diameter becomes for example 1 mm smaller than the diameter of the inner cylindrical surface 22. Then, the vibration system is assembled so that the center axes of the diaphragm 1 and cylindrical surface 22 coincide. As a result, the space between the outer circumference of the diaphragm 1 and the cylindrical surface 22 forms an even space of a width of 0.5 mm and a length of 20 mm. Further, the previously explained openings formed by the ventilation cutaways 8 and 9 are shown in the figures.

The suspension connecting piece 14 illustrated above the external magnetic pole 23 is fastened to the frame member 2 of the diaphragm 1 (black dots in figure show fastening spots), while the second leaf springs 13 are fastened at the C points to the external magnetic pole 23. Below the external magnetic pole 23, another suspension is shown. The connecting piece is fastened to the bottom end of the bobbin 4, while the second leaf springs are fastened to the yoke 26. Note that members to which the second leaf springs are fastened are not limited to an external magnetic pole or yoke, and may also be part of the frame or another unmovable part. When current is passed through the coil 5, this vibration system vibrates in the Z-direction and emits sound.

An example of the frequency response curve obtained by an edgeless plane diaphragm speaker configured in this way will be shown next. FIG. 4 shows the response curve of a speaker having a diaphragm with a diameter of 120 mm. In the figure, A indicates the human audible bandwidth of 20 Hz to 20 kHz. In the figure, a high frequency characteristic resonance is observed at about 4 kHz. In the low frequency region of 30 to 100 Hz, the sound pressure level does not fall. FIG. 5 shows the curve of a speaker having a diaphragm of a diameter of 26 mm. A high frequency resonance is observed at about 30 kHz. These two high resonance frequencies are much higher than those of conventional speakers and show that the diaphragm is high in stiffness.

Regardless of being the cone type or plane diaphragm type, in the frequency response curve of conventional speakers, there are many peaks and bottoms in ranges below the highest resonance frequency. This is because a diaphragm has many characteristic resonance modes, and resonance occurs at each frequency. Further, resonance also occurs in the suspensions. Influence of all these resonance appear in the frequency response curve. On the other hand, as shown in FIG. 4 and FIG. 5, the speaker according to the present invention has a single high resonance frequency. No resonance is recognized in the range below it, that is, the response curve is flat.

The above mentioned two speakers and dividing network (band filter) may be used to configure a 2-way speaker system. The speaker of FIG. 4 is used as a woofer, and the network cuts off the sound at range higher than for example 2 kHz. Further, the speaker of FIG. 5 is used as a tweeter, and the network cuts off the sound at range lower than for example 2 kHz. Note that the resonance of the tweeter at about 30 kHz is outside the human audible range, so is not a problem. In the 2-way speaker systems configured in this way, the frequency response curve is approximately flat in the audible band, no characteristic resonance can be observed, a low frequency sound is also sufficiently reproduced, and an extremely high fidelity sound can be obtained.

### INDUSTRIAL APPLICABILITY

According to the present invention, it is possible to solve the many problems in vibration systems of conventional loudspeakers, so the value of use is large. In particular, if applying the present invention to an edgeless plane diaphragm speaker, it is possible to provide a hi-fi speaker system reproducing original sound with a high fidelity over all audible range.

### BRIEF DESCRIPTION OF THE DRAWINGS

FIG. 1 A perspective view of a vibration system of a loudspeaker of an embodiment of the present invention.

FIG. 2 A perspective view of a suspension of an embodiment of the present invention.

FIG. 3 A front view of an edgeless plane diaphragm speaker of an embodiment of the present invention (including a partial cross-sectional view).

FIG. 4 A frequency response curve of an edgeless plane diaphragm speaker according to the present invention.

FIG. 5 A frequency response curve of an edgeless plane diaphragm speaker according to the present invention.

FIG. 6 A view for explaining the operation of the plate when force is applied to the plate.

FIG. 7 A similar view for explaining the operation of the plate.

FIG. 8 A similar view for explaining the operation of the plate.

FIG. 9 Across-sectional view of a conventional edgeless plane diaphragm speaker.

FIG. 10 A plan view including a partially cutaway part of a conventional plane diaphragm.

FIG. 11 A plan view including a partially cutaway part of another conventional plane diaphragm.

FIG. 12 A cross-sectional view of a cell of a conventional plane diaphragm.

FIG. 13 A front view of a conventional plane diaphragm shown in FIG. 11.

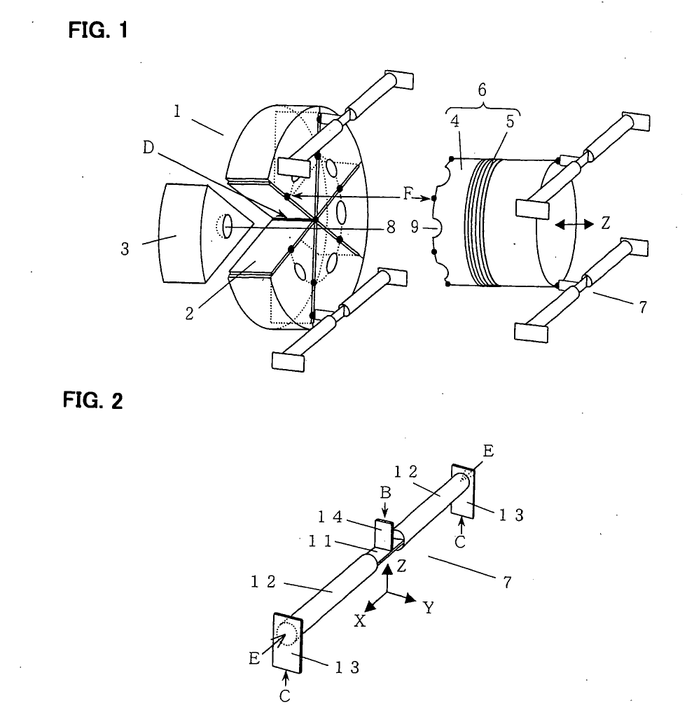

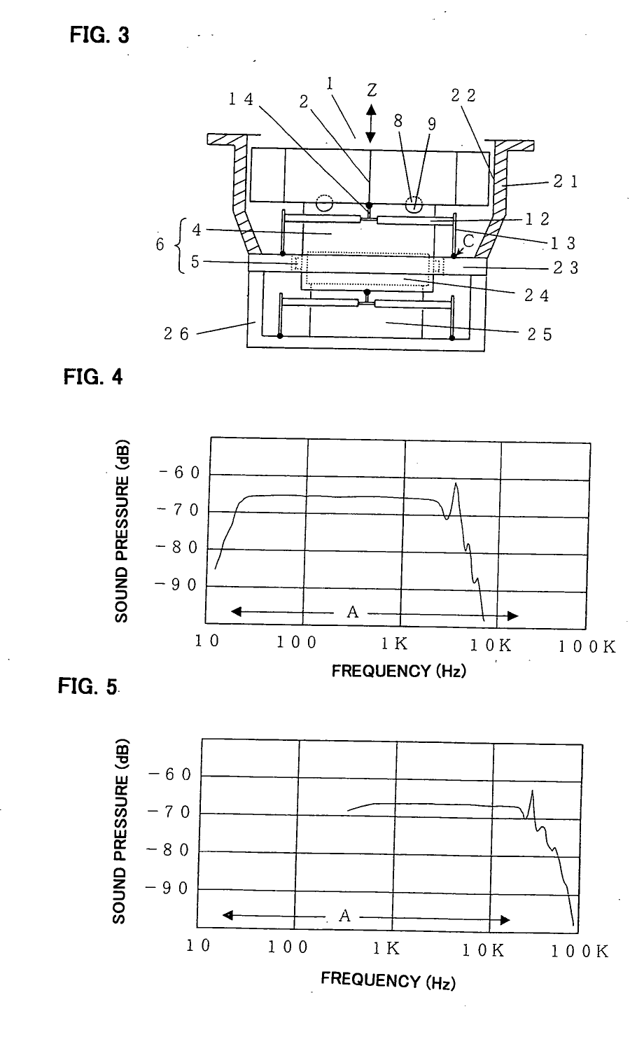

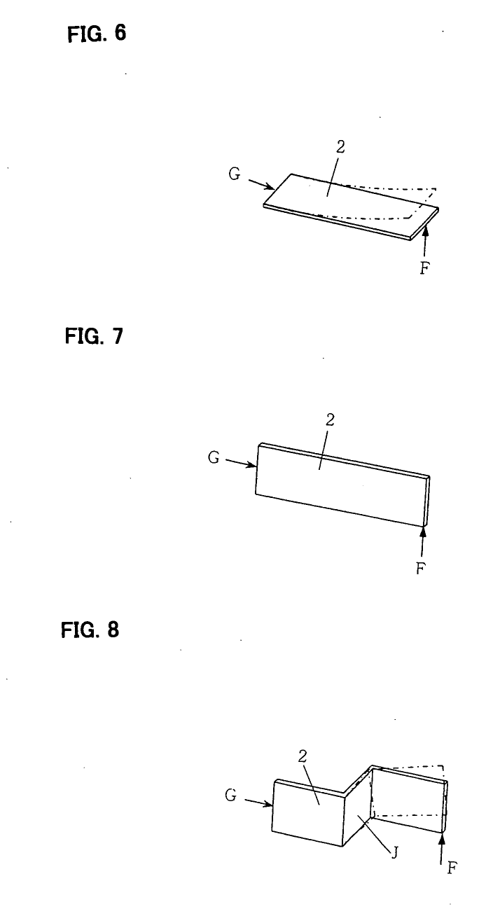

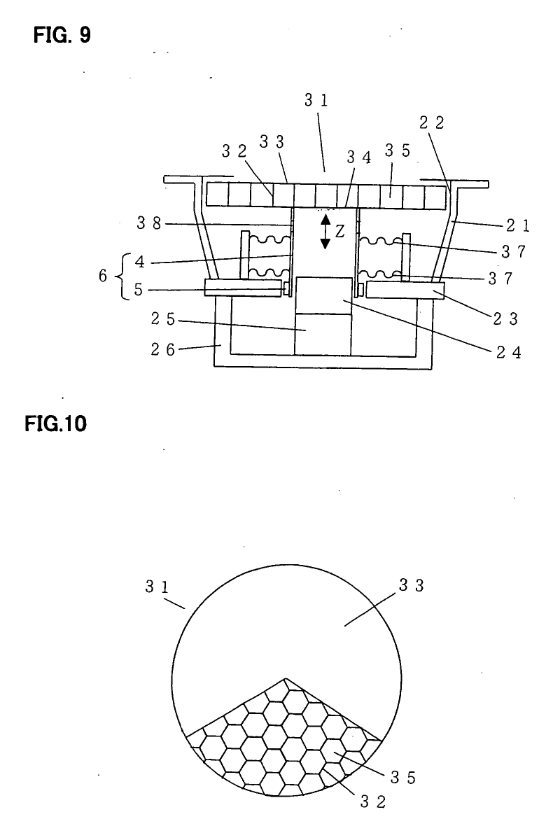

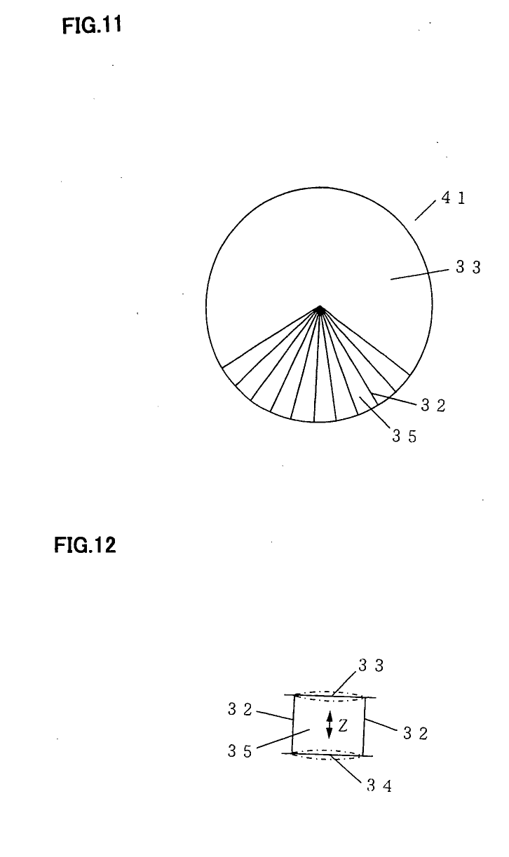

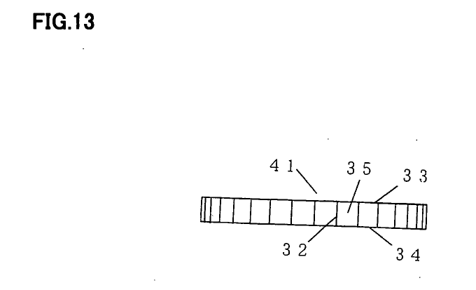

### DESCRIPTION OF NOTATIONS

1 diaphragm
2 frame member (plate member)
3 filler member
4 bobbin
5 coil
6 drive part
7 suspension
8 ventilation cutaway
9 ventilation cutaway

1. A loudspeaker provided with a diaphragm for emitting a sound and a drive part for driving said diaphragm, wherein
said diaphragm is comprised of
a frame member comprised of a plurality of flat plate members arranged in parallel to a vibration direction and radiating from a center of said diaphragm toward an outer circumference and having ends fastened together at a radial center and
filler members filling space formed between any two adjoining flat plate members, having two sides thereby fastened to said flat plate members, and emitting sound from surfaces thereof.

2. A loudspeaker as set forth in claim 1, wherein said diaphragm has a circular outer circumference, said plurality of flat plate members are the same in shape and are arranged radially at substantially equal angular intervals in the circumferential direction, and said filler members are fan shaped.

3. A loudspeaker as set forth in claim 1, wherein said filler members are composed of foamed materials.

4. A loudspeaker as set forth in claim 1, wherein said frame member has an outer circumferential end positioned inside from an outer circumferential surface of said diaphragm determined by the outer circumferential surfaces of said filler members.

5. A loudspeaker as set forth in claim 1, wherein said drive part is fastened to the same sides of each of the plurality of said flat plate members forming said frame member and transmits vibration through said frame member to said filler members.

6. A loudspeaker as set forth in claim 5, wherein parts of at least one of said filler members and said drive part where said filler members and said drive part face each other are provided with ventilation cutaways.

7. A loudspeaker as set forth in claim 1, wherein at least one of said diaphragm and said drive part is supported by suspensions, each suspension structured so that rod-like members are fastened in a line to the both ends of a first leaf spring, second leaf springs are fastened perpendicularly to said rod-like members at the both ends of said rod-like members, the both ends of said second leaf springs are fastened to unmovable parts of said loudspeaker.

8. A diaphragm for a loudspeaker and for emitting sound, comprising
a frame member comprised of a plurality of flat plate members arranged in parallel to a vibration direction and radiating from a center of said diaphragm toward an outer circumference and having ends fastened together at a radial center and
filler members filling space formed between any two adjoining flat plate members, having two sides fastened to said flat plate members, and emitting sound from surfaces thereof.

9. A diaphragm for a loudspeaker as set forth in claim 8, wherein said diaphragm has a circular outer circumference, said plurality of flat plate members are the same in shape and are arranged radially at substantially equal angular intervals in the circumferential direction, and said filler members are fan shaped.

10. A diaphragm for a loudspeaker as set forth in claim 8, wherein said filler members are composed of foamed materials.

11. A diaphragm for a loudspeaker as set forth in claim 1, wherein said frame member has an outer circumferential end positioned inside from an outer circumferential surface of said diaphragm determined by the outer circumferential surfaces of said filler members.

12. A diaphragm for a loudspeaker as set forth in claim 8, wherein said drive part is fastened to the same sides of the plurality of said flat plate members forming said frame member and transmits vibration through said frame member to said filler members.

13. A diaphragm for a loudspeaker as set forth in claim 12, wherein parts of at least one of said filler members and said drive part where said filler members and said drive part face each other are provided with ventilation cutaways.

14. A suspension for supporting at least one of a diaphragm and drive part of a loudspeaker, structured so that
rod-like members are fastened in a line to the both ends of a first leaf spring, second leaf springs are fastened perpendicularly to said rod-like members at to the both ends of said rod-like members,
the both ends of said second leaf springs are fastened to unmovable parts of said speaker.

15. A loudspeaker as set forth in claim 1, wherein said first leaf spring is fastened to at least one of said diaphragm and said drive part through a connecting piece.

16. A loudspeaker as set forth in claim 1, wherein said first leaf spring is fastened to at least one of said diaphragm and said drive part through a connecting piece.
